(19) United States
(12) Patent Application Publication
(10) Pub. No.: US 2014/0085308 A1
(43) Pub. Date: Mar. 27, 2014

(54) User Interface Incorporating Waterfall Chart

(71) Applicant: SAP AG, Walldorf (DE)

(72) Inventors: Ziqiang Huang, Shanghai (CN); Hua Wang, Shanghai (CN); Josef Ehbauer, Weingarten (DE); Michael Rey, Speyer (DE); Weicheng Mao, Shanghai (DE)

(73) Assignee: SAP AG, Walldorf (DE)

(21) Appl. No.: 13/649,874

(22) Filed: Oct. 11, 2012

(30) Foreign Application Priority Data
Sep. 25, 2012 (CN) 201210355641.X

(51) Int. Cl. G06T 11/20

(52) U.S. Cl. 345/440.2

(57) ABSTRACT

A user interface to a data warehouse includes an interface engine that is configured to present data in the format of a waterfall chart. Based upon data received from the data warehouse and input from the user (e.g. color schemes, the order of the columns), the interface engine is configured to display a waterfall chart. In such a waterfall chart, data may be presented in the form of vertical (or horizontal) bars growing in different directions from different zero points, rather than in a uniform direction from the same zero point (e.g. from an axis origin). The interface engine may employ color and/or other techniques to present the data of the waterfall chart. Embodiments may be particularly suited for the presentation of certain types of business information, for example data relevant to a profit margin decomposition analysis.

### CROSS-REFERENCE TO RELATED APPLICATION

The instant U.S. nonprovisional patent application claims priority to Chinese Patent Application No. 201210355641.X filed Sep. 25, 2012, which is incorporated by reference in its entirety herein for all purposes.

### BACKGROUND

Embodiments of the present invention relate to user interfaces to data warehouse systems, and in particular, to a user interface incorporating a waterfall chart display.

Unless otherwise indicated herein, the approaches described in this section are not prior art to the claims in this application and are not admitted to be prior art by inclusion in this section.

Data warehouse systems offer a user the opportunity to store and analyze a large volume and variety of business information. Such information from the data warehouse is accessible to the user through an interface.

User interfaces to a data warehouse may offer different types of views that allow the visualization and analysis of stored data. One common type of view is a bar chart, where data of each column (in the case of a vertically-oriented bar chart) or each row (in the case of a horizontally-oriented bar chart) grows from the zero position of the respective axis (horizontal or vertical). While conventional bar charts may be useful in presenting data, they may not be the optimal format for visualizing relationships relevant to certain analyses.

Accordingly, the present disclosure addresses these and other issues with a user interface incorporating a waterfall chart display.

### SUMMARY

A user interface to a data warehouse includes an interface engine that is configured to present data in the format of a waterfall chart. Based upon data received from the data warehouse and input from the user (e.g. color schemes, the order of the columns), the interface engine is configured to display a waterfall chart. In such a waterfall chart, data may be presented in the form of vertical (or horizontal) bars growing in different directions from different zero points, rather than in a uniform direction from the same zero point (e.g. from an axis origin). The interface engine may employ color and/or other techniques to present the data of the waterfall chart. Embodiments may be particularly suited for the presentation of certain types of business information, for example data relevant to a margin decomposition analysis.

An embodiment of a computer-implemented method comprises causing an interface engine to receive an instruction to display data retrieved from a database, in waterfall chart format. The method further comprises causing the interface engine to create from the data, a waterfall chart comprising a first axis, a second axis orthogonal to the first axis, a first entry having a first growth range and a first growth point relative to the first axis, and a second entry having a second growth range and a second growth point different from the first growth point. The method further comprises causing the interface engine to communicate the waterfall chart for display on a user device.

An embodiment of a non-transitory computer readable storage medium embodies a computer program for performing a method comprising causing an interface engine to receive an instruction to display data retrieved from a database, in waterfall chart format. The method further comprises causing the interface engine to create from the data, a waterfall chart comprising a first axis, a second axis orthogonal to the first axis, a first entry having a first growth range and a first growth point relative to the first axis, and a second entry having a second growth range and a second growth point different from the first growth point. The method further comprises causing the interface engine to communicate the waterfall chart for display on a user device.

An embodiment of a computer system comprises one or more processors and a software program executable on said computer system. The software program is configured to cause an interface engine to receive an instruction to display data retrieved from a database, in waterfall chart format. The software program is further configured to cause the interface engine to create from the data, a waterfall chart comprising a first axis, a second axis orthogonal to the first axis, a first entry having a first growth range and a first growth point relative to the first axis, and a second entry having a second growth range and a second growth point different from the first growth point. The software program is further configured to cause the interface engine to communicate the waterfall chart for display on a user device.

In certain embodiments the first entry is displayed with a first color, and the second entry is displayed with a second color different from the first color.

According to some embodiments the first entry is displayed with a first type of cross-hatching, and the second entry is displayed with a second type of cross-hatching different from the first type of cross-hatching.

In various embodiments a polarity of the first growth range determines a direction of growth of the first entry from growth point along the second axis.

According to specific embodiments a first portion of the first entry located below the first axis, is colored differently from a second portion of the first entry located above the first axis.

In certain embodiments the second axis is vertically oriented.

In some embodiments the first entry comprises a first component of a profit margin, and the second entry comprises a second component of the profit margin.

The following detailed description and accompanying drawings provide a better understanding of the nature and advantages of particular embodiments.

### BRIEF DESCRIPTION OF THE DRAWINGS

FIG. 1A shows a simplified view of a vertically-oriented waterfall chart.

FIG. 1B shows a simplified view of a horizontally-oriented waterfall chart.

FIG. 2A shows a simplified view of an interface system according to an embodiment.

FIG. 2B is a simplified flow diagram showing a process according to an embodiment.

FIG. 3 is an example of a waterfall chart created according to an embodiment.

FIG. 4 illustrates hardware of a special purpose computing machine configured to provide a user interface according to an embodiment.

FIG. 5 illustrates an example of a computer system.

### DETAILED DESCRIPTION

Described herein are techniques for providing a user interface. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

A user interface to a data warehouse includes an interface engine that is configured to present data in the format of a waterfall chart. Based upon data received from the data warehouse and input from the user (e.g. color schemes, the order of the columns), the interface engine is configured to display a waterfall chart. In such a waterfall chart, data may be presented in the form of vertical (or horizontal) bars growing in different directions from different zero points, rather than in a uniform direction from the same zero point (e.g. from an axis origin). The interface engine may employ color and/or other techniques to present the data of the waterfall chart. Embodiments may be particularly suited for the presentation of certain types of business information, for example data relevant to a margin decomposition analysis.

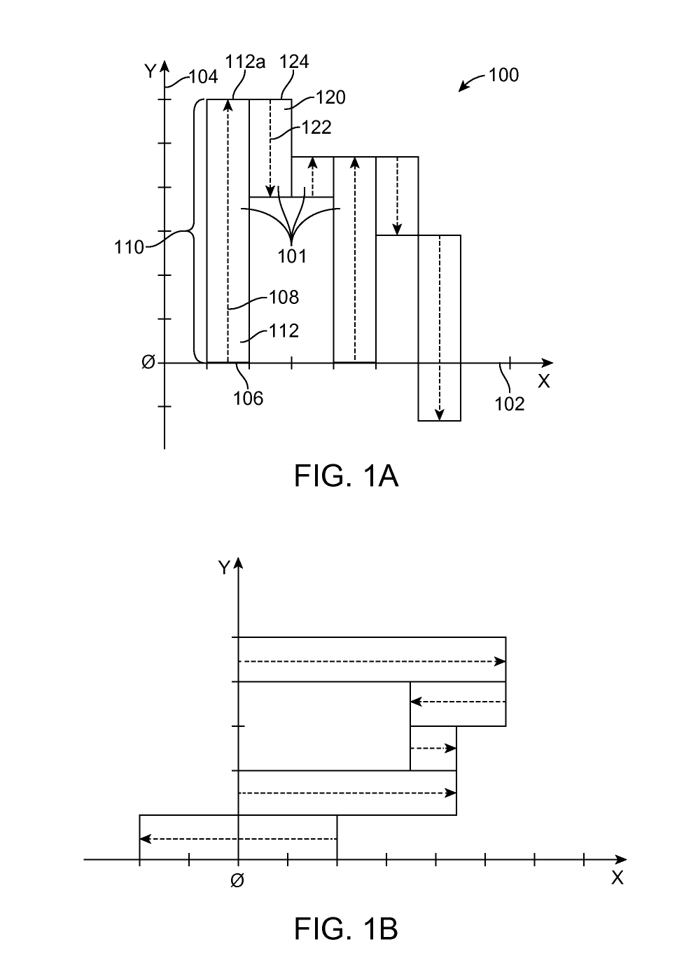

FIG. 1A is a generic view of a waterfall chart created by an interface engine according to an embodiment. The waterfall chart 100 includes an X-axis 102 and a Y-axis 104 orthogonal thereto.

The waterfall chart comprises a plurality of entries 101 oriented from left to right (e.g. the manner of reading the English language). Each entry comprises a vertical column having a growth point 106, a growth direction 108 (indicated by a dashed arrow), and a growth range 110.

In particular, a first entry comprises the vertical column 112. The column 112 is grown from a growth point (the zero value of the X-axis) in a first (upward) direction over a growth range of five units along the Y-axis.

A second entry comprises another vertical column 120. The column 120 is grown in a second (downward) direction 122 from a different growth point 124, here corresponding to the top 112a of the first vertical column.

While FIG. 1A shows a waterfall chart that is oriented in a vertical direction (e.g. the growth direction is in the vertical direction along the Y-axis), this is not required. Particular embodiments of user interfaces could provide a display of a chart that is oriented in a horizontal direction, with a growth direction in the horizontal direction along the X-axis. One such alternative embodiment of a waterfall chart is shown in FIG. 1B.

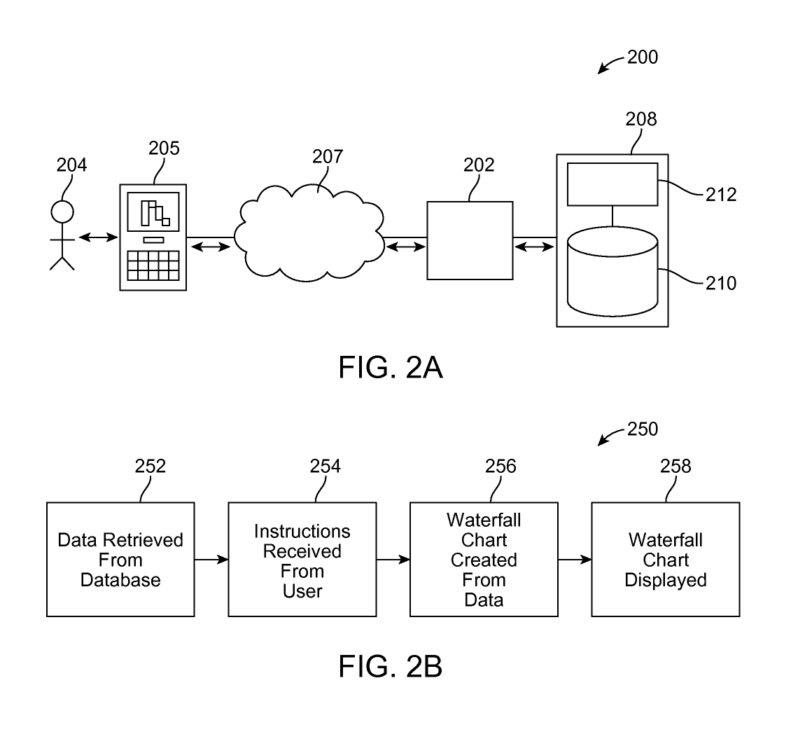

FIG. 2A shows a simplified view of an embodiment of a system which may be employed to provide a user interface to a data warehouse according to an embodiment. The system 200 comprises processor including an interface engine 202 that is in communication with a user 204 via a user device 205 and a communications network 207.

The user device may be terminal, a separate desktop computer, a laptop computer, a workstation, a smartphone, or a tablet, depending upon the particular embodiment. Also depending upon the embodiment, the communications network may be wired, wireless, or some combination thereof.

The interface engine 202 is in turn in communication with a data warehouse 208. This data warehouse may comprise a database 210 having information stored therein according to various data structures, together with a database engine 212 configured to add or manipulate data within the database.

According to various embodiments, the interface engine receives instructions from the user. Such instructions would define the desired appearance of the entries to the chart that is to be created from the data stored in the database.

Based upon the instructions, the interface engine could assign parameters to the various waterfall column chart entries. For example, the interface engine could assign the growth point to each entry to place it in the desired position on the screen/page.

The interface engine could also assign the growth range indicating the magnitude of the entry to the chart. In certain embodiments, the polarity of the growth range would determine the growth direction. For example, a negative growth range would indicate growth of the entry in a direction opposite to an entry having a positive growth range.

The interface engine could also assign the sequence of entries based upon user instructions. For example, in a vertically-oriented waterfall chart it may be appropriate to position the entity with the largest growth range at the left side proximate to the origin, consistent with the natural left-to-right movement of the reader's eyes on the screen or page.

In a horizontally-oriented waterfall chart, however, it may be appropriate to position the entity with the largest growth range at the top, distal from the origin. Such a layout would be consistent with natural top-to-bottom movement of the reader's eyes on the screen/page.

Input by the user could define still other attributes of the resulting chart displayed by the user interface. For example, user input could determine the scale of the axis along which the growth range occurs, and also the scale/manner of separation of different entities along the other axis.

Various embodiments could display information in three spatial dimensions (e.g. along three axes). Thus user input could also determine characteristics of the graph such as the nature of the axes, and the particular perspective of the view of any three dimensional chart being displayed.

Moreover, as shown and discussed in the Example below, color may be used to impart information to a chart. Accordingly, user input may determine the color assigned to a particular entity.

Furthermore, user input could also determine background and/or foreground colors of the chart, for example to facilitate recognition of positive and negative areas in order to make the chart more meaningful. Other visual techniques that may be determined by user input can include but are not limited to, cross-hatching, animations, and supporting groups of entities, for example a display margin decomposition chart of multiple companies or products.

FIG. 2B is a simplified flow diagram showing a process 250 according to an embodiment. In a step 252, an interface engine retrieves certain data from a data warehouse.

In step 254, the interface engine receives instructions from a user to display the data in the format of a waterfall chart. According to particular embodiments, these instructions may include a zero point and a growth range for each entry. According to some embodiments, the user instructions may be in the form of input that is translated by the interface engine into a zero point and a growth range for each entry.

In a next step 256, the interface engine creates from the data, a waterfall chart comprising a plurality of entries, each having a zero point and a growth range. In the next step 258, the interface engine causes the waterfall chart to be displayed to the user.

### Example

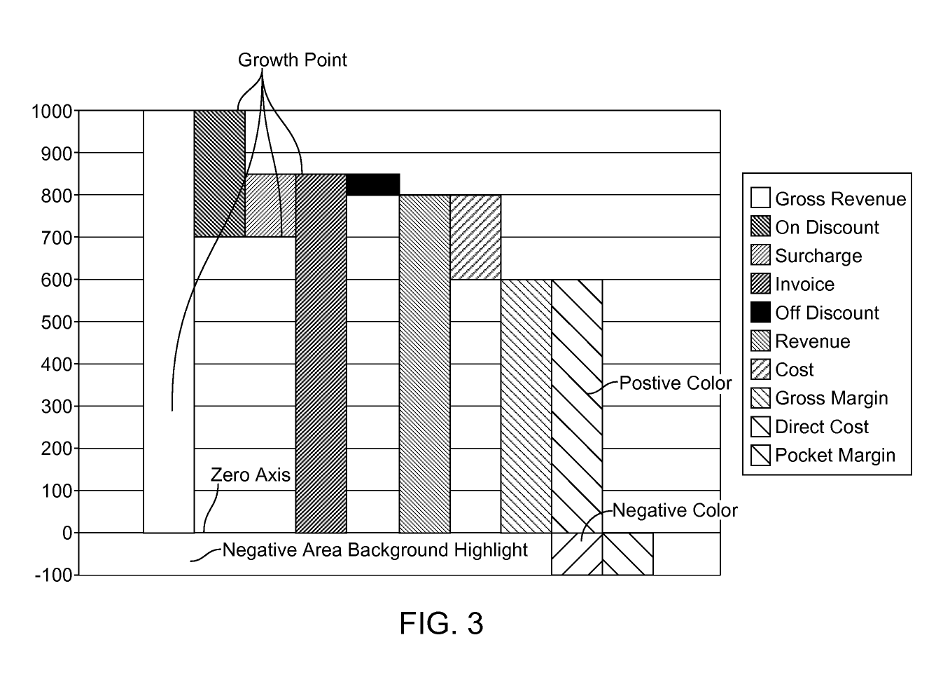

FIG. 3 is a simplified view of an example of the presentation of data from a business warehouse as a waterfall chart. In particular, this waterfall chart provides data relevant to a profit margin decomposition analysis.

In FIG. 3, the vertical axis represents an amount of money in US dollars ($). In FIG. 3, the horizontal axis represents different components of a profit margin value stored in a data warehouse.

Unlike with a conventional column chart, in the waterfall chart of FIG. 3 each column grows from its own growth point, which may be other than the origin of the Y-axis. This particular manner of presentation of the margin data, facilitates user recognition and appreciation of the role played by each margin component.

The specific waterfall chart of the example of FIG. 3 also employs color to impart additional information regarding the data being presented. For example, the various margin components are presented in different colors according to the following scheme.

| Margin Component | Color |
|---|---|
| Gross Revenue | Dark Blue |
| On Discount | Orange |
| Surcharge | Gray |
| Invoice | Royal Blue |
| Off Discount | Light Orange |
| Revenue | Light Blue |
| Cost | Red |
| Gross Margin | Green |
| Direct Cost | Dark Orange; Faded Dark Orange |
| Pocket Margin | Faded Light Green |

In the specific FIG. 3 used herein, the colors are represented by different forms of cross-hatching as a shorthand consistent with the black-and-white nature of a patent application. In certain embodiments, however, cross-hatching may actually be used in the chart displayed, in place of or in supplement to, coloration.

Color may also be employed to indicate a polarity of the information being presented. In FIG. 3, the area below the origin of the vertical axis is displayed with a gray highlight. This has the result of differentiating (and highlighting) negative information, and also affects the color of the respective component to indicate its negative nature.

Each column of chart could thus be assigned specific colors for both positive area and negative area. In the particular example of FIG. 3, the negative portion of the Direct Cost component is a different (faded) orange hue from the positive portion of that component. Here, the Pocket Margin component is entirely negative, as represented by a different (faded) light green hue.

In the specific example of FIG. 3, techniques other than color are employed to impart specific information to a user. For example in FIG. 3 the components are listed in a specific order from left to right along the X-axis.

Displaying information in the form of a waterfall chart as in FIG. 3, facilitates review by a user. This may be seen by contrasting the example of the waterfall chart of FIG. 3, with the same data presented in a format where all columns are plotted from the same zero point. Owing to the format in which it is presented, the data in FIG. 3 is much easier to comprehend and analyze by a user.

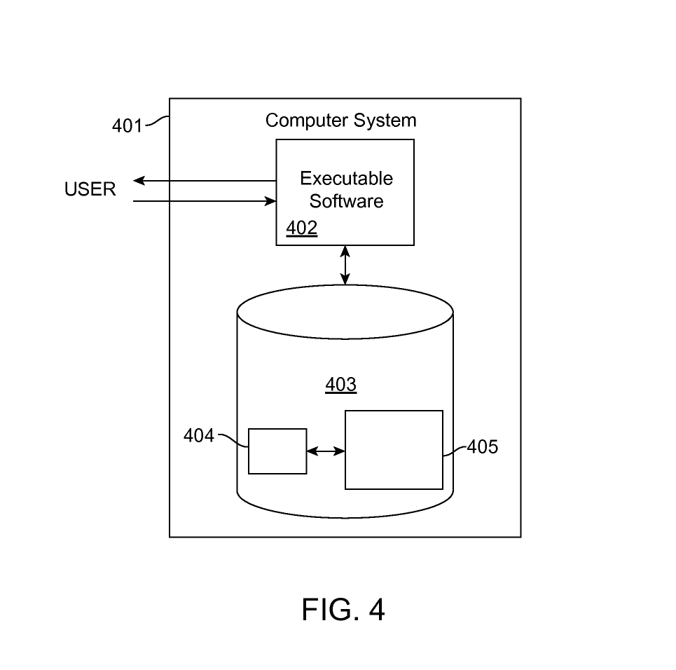

FIG. 4 illustrates hardware of a special purpose computing machine configured to provide a user interface according to an embodiment. In particular, computer system 400 comprises a processor 402 that is in electronic communication with a non-transitory computer-readable storage medium 403. This computer-readable storage medium has stored thereon code 405 corresponding to an interface engine. Code 404 corresponds to the data that is to be displayed by the interface engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

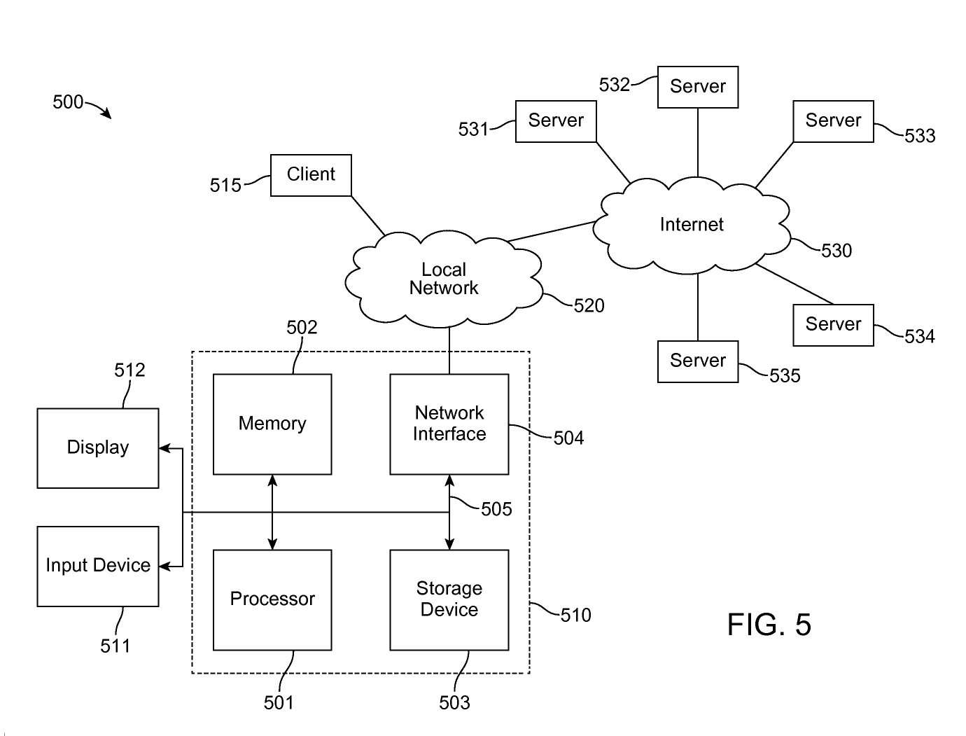

An example computer system 510 is illustrated in FIG. 5. Computer system 510 includes a bus 505 or other communication mechanism for communicating information, and a processor 501 coupled with bus 505 for processing information. Computer system 510 also includes a memory 502 coupled to bus 505 for storing information and instructions to be executed by processor 501, including information and instructions for performing the techniques described above, for example. This memory may also be used for storing variables or other intermediate information during execution of instructions to be executed by processor 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 503 may include source code, binary code, or software files for performing the techniques above, for example. Storage device and memory are both examples of computer readable mediums.

Computer system 510 may be coupled via bus 505 to a display 512, such as a cathode ray tube (CRT) or liquid crystal display (LCD), for displaying information to a computer user. An input device 511 such as a keyboard and/or mouse is coupled to bus 505 for communicating information and command selections from the user to processor 501. The combination of these components allows the user to communicate with the system. In some systems, bus 505 may be divided into multiple specialized buses.

Computer system 510 also includes a network interface 504 coupled with bus 505. Network interface 504 may provide two-way data communication between computer system 510 and the local network 520. The network interface 504 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 504 sends and receives electrical, electromagnetic, or optical signals that carry digital data streams representing various types of information.

Computer system 510 can send and receive information, including messages or other interface actions, through the network interface 504 across a local network 520, an Intranet, or the Internet 530. For a local network, computer system 510 may communicate with a plurality of other computer machines, such as servers 531-535. Accordingly, computer system 510 and server computer systems represented by servers 531-535 may form a cloud computing network, which may be programmed with processes described herein. In the Internet example, software components or services may reside on multiple different computer systems 510 or servers 531-535 across the network. The processes described above may be implemented on one or more servers, for example. A server 531 may transmit actions or messages from one component, through Internet 530, local network 520, and network interface 504 to a component on computer system 510. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
causing an interface engine to receive an instruction to display data retrieved from a database, in waterfall chart format;
causing the interface engine to create from the data, a waterfall chart comprising,
a first axis,
a second axis orthogonal to the first axis,
a first entry having a first growth range and a first growth point relative to the first axis, and
a second entry having a second growth range and a second growth point different from the first growth point; and
causing the interface engine to communicate the waterfall chart for display on a user device.

2. A method as in claim 1 wherein the first entry is displayed with a first color, and the second entry is displayed with a second color different from the first color.

3. A method as in claim 1 wherein the first entry is displayed with a first type of cross-hatching, and the second entry is displayed with a second type of cross-hatching different from the first type of cross-hatching.

4. A method as in claim 1 wherein a polarity of the first growth range determines a direction of growth of the first entry from growth point along the second axis.

5. A method as in claim 1 wherein a first portion of the first entry located below the first axis, is colored differently from a second portion of the first entry located above the first axis.

6. A method as in claim 1 wherein the second axis is vertically oriented.

7. A method as in claim 1 wherein the first entry comprises a first component of a profit margin, and the second entry comprises a second component of the profit margin.

8. A non-transitory computer readable storage medium embodying a computer program for performing a method, said method comprising:
causing an interface engine to receive an instruction to display data retrieved from a database, in waterfall chart format;
causing the interface engine to create from the data, a waterfall chart comprising,
a first axis,
a second axis orthogonal to the first axis,
a first entry having a first growth range and a first growth point relative to the first axis, and
a second entry having a second growth range and a second growth point different from the first growth point; and
causing the interface engine to communicate the waterfall chart for display on a user device.

9. A non-transitory computer readable storage medium as in claim 8 wherein the first entry is displayed with a first color, and the second entry is displayed with a second color different from the first color.

10. A non-transitory computer readable storage medium as in claim 8 wherein the first entry is displayed with a first type of cross-hatching, and the second entry is displayed with a second type of cross-hatching different from the first type of cross-hatching.

11. A non-transitory computer readable storage medium as in claim 8 wherein a polarity of the first growth range determines a direction of growth of the first entry from growth point along the second axis.

12. A non-transitory computer readable storage medium as in claim 8 wherein a first portion of the first entry located below the first axis, is colored differently from a second portion of the first entry located above the first axis.

13. A non-transitory computer readable storage medium as in claim 8 wherein the second axis is vertically oriented.

14. A non-transitory computer readable storage medium as in claim 8 wherein the first entry comprises a first component of a profit margin, and the second entry comprises a second component of the profit margin.

15. A computer system comprising:
one or more processors;
a software program, executable on said computer system, the software program configured to:
cause an interface engine to receive an instruction to display data retrieved from a database, in waterfall chart format;
cause the interface engine to create from the data, a waterfall chart comprising,
a first axis,
a second axis orthogonal to the first axis,
a first entry having a first growth range and a first growth point relative to the first axis, and
a second entry having a second growth range and a second growth point different from the first growth point; and
cause the interface engine to communicate the waterfall chart for display on a user device.

16. A computer system as in claim 15 wherein the first entry is displayed with a first color, and the second entry is displayed with a second color different from the first color.

17. A computer system as in claim 15 wherein the first entry is displayed with a first type of cross-hatching, and the second entry is displayed with a second type of cross-hatching different from the first type of cross-hatching.

18. A computer system as in claim 15 wherein a polarity of the first growth range determines a direction of growth of the first entry from growth point along the second axis.

19. A computer system as in claim 15 wherein a first portion of the first entry located below the first axis, is colored differently from a second portion of the first entry located above the first axis.

20. A computer system as in claim 15 wherein the first entry comprises a first component of a profit margin, and the second entry comprises a second component of the profit margin.
